(19) United States
(12) Patent Application Publication
(10) Pub. No.: US 2004/0058109 A1
(43) Pub. Date: Mar. 25, 2004

(54) Use of foamed adhesives to make paper cores or tubes

(76) Inventors: Peter D. Pierce, Washington Crossing, PA (US); David W. Lydzinski, Belle Mead, NJ (US); Christian E. Russell, High Bridge, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/616,340

(22) Filed: Jul. 9, 2003

Related U.S. Application Data
(63) Continuation of application No. 09/265,225, filed on Mar. 10, 1999.

(51) Int. Cl. B32B 1/08

(52) U.S. Cl. 428/36.9

(57) ABSTRACT

The use of adhesives formulated with up to 40% foam in paper cores and tubes for the tissue, towel, carpet, textile, plastic film, paper, food and industrial storage industries.

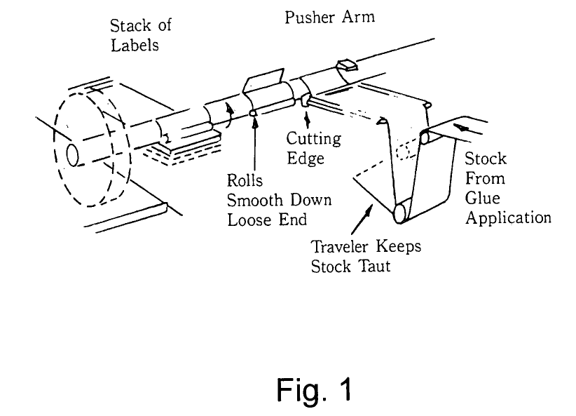

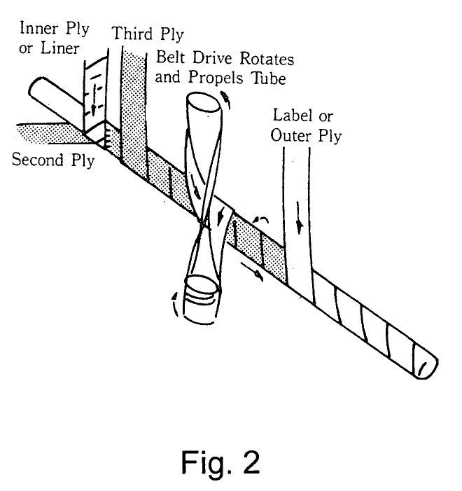

### BACKGROUND OF THE INVENTION

Cores are a paper or paperboard construction around which material is wound. The material can be tissue or towel, carpet, textile, plastic film, paper or any other material that is would around a core. A tube is a container that is used to transport or store various dry foods, refrigerated foods or dough, oils and other liquids; and is also used for various other industrial applications. Cores or tubes can be made using single or multiple plies of substrates.

When making paper cores or tubes the selection and application of the adhesive can have a significant impact on the efficiency of the process. Top speed capability, the amount of time required to go from initial start up to full speed, scrap rate, and the quality of finished cores and tubes are all affected by the adhesive chosen.

There are two basic methods for making a core. Convolute winding uses a web of paper that is as wide as the resulting core is long. A mandrel spins and winds the paper onto itself forming the core. The adhesive is continuously applied to the ply material as the core is wound.

[image]

Spiral winding comprises continuous winding of 2 or more plies around a mandrel at an angle causing the length of the core to grow as the plies are wound. The adhesive is continuously applied to the ply material as the core or tube is wound.

[image]

Aqueous adhesives, and aqueous foamed adhesives, are known to be useful for adhering paper. Japanese Patent Application 56-30050. Aqueous adhesives are also used in paper core manufacture, however the aqueous nature of the adhesive in this application presents numerous problems.

Water based adhesives must dissipate water before a bond can be formed. The water dissipates due to evaporation and/or absorption into the substrates (plies), and in the process the adhesive becomes tacky. Therefore an adhesive with the least amount of water is the most desired. However, a water based adhesive must comprise enough water so when applied, the adhesive is sufficiently wet at the time of contact to ensure that both plies, that are to be bonded together, are wetted by the adhesive. This dichotomy, of the adhesive being wet enough to affect the surfaces of the plies, but not too wet such that the bond takes a long time to form, raises concerns for the core and tube construction industry. In core and tube construction, as the winder speed is increased, the amount of time for water to dissipate decreases. Without adjustments by the operator of the machinery to reduce the amount of adhesive applied, the wet adhesive layer can cause ply slippage and shutdown, or “dog ears” at the cut off saw. The term “dog ears” refers to ply separation during the core cutting stage; the ply typically folds back upon itself resembling a dog's ear.

The absorptive characteristics of the ply material also have a significant impact on the adhesive performance when aqueous adhesives are used. If the ply material is too absorbent, the adhesive penetrates the ply material and precures (becomes dry) before the ply is wound on the mandrel. If the ply material is made of an nonabsorbent material, the coated ply is likely to be too wet when it comes in contact with another ply, thus causing slippage.

With conventional high speed corewinding equipment, adjustment must be made to the adhesive application amount when production speeds are changed. For example, at high speeds, too much adhesive can be applied, resulting in soft or soggy cores (due to excessive moisture from adhesive) and ply slippage. If the adhesive amount is reduced to compensate for the increased line speeds, problems occur when machine speeds are later reduced as required by the production method. These problems arise due to less adhesive open time (bonding time). If the adhesive is left open to the air for too long, it will dry out or penetrate, and adhesion to another ply cannot occur.

It has been found, in accordance with the present invention, that introduction of foam into adhesives formulated for paper cores or tubes, overcomes some of the problems discussed above. Introduction of foam into the adhesive widens the adhesive operating window and improves the efficiency of the core making process.

Specifically, foamed adhesives do not penetrate porous surfaces to the same extent as nonfoamed adhesives and therefore open time increases and the tendency to precure decreases. In addition, in any given film thickness, a foamed adhesive contains less water than an unfoamed adhesive. With less water to dissipate, a bond forms more quickly upon compression reducing the possibility of ply slippage and/or “dog ears”. Also, the possibility of producing soft and/or soggy cores or tubes is reduced.

The foamed adhesives of the present invention allow tube/core manufacturers to use less adhesive and therefore add less moisture to the core construction. The reduced adhesive content per a given volume allows high speeds to be obtained without adjustments to application amount. In addition, at slow speeds, these adhesives will not permeate the surface of a substrate, therefore allowing acceptable core/tube production.

### SUMMARY OF THE INVENTION

It has been found, in accordance with the present invention, that foaming waterbased adhesives provides an unexpected benefit in the construction of paper cores or tubes. The present invention is directed to adhesives formulated with up to 40% foam by weight added and the use of these adhesives in paper cores and tubes.

### DETAILED DESCRIPTION OF THE INVENTION

The present invention is directed to aqueous adhesives formulated with up to 40% by weight foam for use in paper cores and tubes. The present invention is also directed to a method of making paper cores and tubes using a foamed adhesive.

The adhesives of the present invention include any conventional aqueous adhesive usable for paper core/tube manufacture. Examples of adhesives that may be foamed include polyvinylacetate homopolymer or copolymer emulsions (neat or formulated with other components), polyvinyl alcohol, dextrins, starches, acrylates, silicates, filled systems and crosslinkables. Preferred are the formulated polyvinyl acetate homopolymer emulsions.

Depending on the conventional adhesive chosen, it may be necessary to modify the adhesive formulation prior to foaming. Specifically, it may be necessary to reduce or remove any defoamers which were originally added to the formulation to inhibit foam generation. For example, a standard polyvinylacetate-based adhesive would not generate consistent foam until the defoamer component was substantially reduced or totally removed from the formula. Since defoamers are typically compounded into the adhesive formulation, adhesive formulated for the present invention should not have any defoamer, or at the minimum as reduced amount.

It may also be necessary to add one or more foaming agents, such as surfactant or soaps to the adhesive composition prior to foaming.

Removal of defoamers and/or adding wetting agents from adhesives can be by methods familiar to one of ordinary skill in the art.

To prepare the foamed adhesives of the present invention, up to 40% by weight foam is added to the conventional adhesive. Foam may be added to the adhesive by methods familiar to one of skill in the art, including mechanical stirring or agitation, introduction of gases, or by chemical reactions. Gases that may be used to introduce foam include air, nitrogen or oxygen. The preferred method of introducing foam into the adhesives of the present invention is via mechanical agitation in situ with gas introduction.

The foamed adhesives of the present invention are applied during the conventional corewinding or tubewinding process used to manufacture paper cores or tubes. Specifically, the foamed adhesives are used in place of conventional adhesives in a conventional corewinding process. In a preferred embodiment, a paper core or tube comprising one or more plies of paper or paperboard are bonded together with an adhesive which has been foamed to 40% by weight.

The foamed adhesives of the present invention contain less water by volume than unfoamed adhesives. In addition, because of the presence of foam, the volume of the adhesive increases allowing less adhesive to be used resulting in faster drying times, a reduction in the amount of adhesive used, and a reduced cure time for the finished core of tube construction. Water in the waterborne adhesive swells the paper fiber in the core or tube construction. As the freshly made core/tube dissipates the water it normally shrinks from its original dimension. As a result, many core/tube processes include a built in “cure time” prior to cutting the construction to its final dimension. The use of the adhesives of the present invention, reduce the dimension change of the final core or tube and minimize the cure time.

Another advantage of the foamed adhesives of the present invention is that they do not penetrate porous surfaces to the same extent as nonfoamed adhesives. This increases open time and decreases the tendency of the adhesive to precure prior to contact with the addition plies. Further, since the foamed adhesive contains less water by volume than an unfoamed adhesive, there is less water to dissipate, and the bond between the plies forms more quickly reducing the possibility of ply slippage and/or “dog ears”. Also, this reduction in the amount of water prevents the production of wet or soggy cores/tubes, which when filled or subjected to further processing, may come apart.

In addition, the foamed adhesives of the present invention allow a much wider operating window of adhesive application amount during changes in production speed. Typically, the production speed of corewinding equipment cannot change without adjustments to the amount of adhesive applied. By using the foamed adhesives of the present invention, corewinding equipment can be run up to 100% maximum line speed with no adjustments to application amount.

The following examples are merely illustrative and not intended to limit the scope of the present invention in any manner.

### EXAMPLES

In the following examples, different adhesive formulations, foamed and unfoamed, were evaluated on conventional core winding machinery. The core stock used in all tests was “30# Blue Chip Core Stock”, 3.27″ wide, 0.010″ thick, from US Paper Mills. The corewinding machine had a maximum speed of 350 core FPM (100%). The glue roll to doctor blade gap was 0.012″.

The adhesive formulations were foamed with air using a foam generator Model 2MT available from E. T. Oaks Corporation.

### Example 1

An ethylene vinyl acetate based adhesive was evaluated; the control was pure adhesive which was compared to a sample foamed to 20% and 40% air by weight. The adhesive comprised 92% EVA, 4.5% polyvinyl alcohol, and 3.5% water. This adhesive was a high solids, fast setting formula with a viscosity of 1500 cPs. The following was observed:

TABLE I

| Sample | Foam | Wind | Fiber Tear | Dog Ears | Cores |
|---|---|---|---|---|---|
| 1 | — | easy | 100% | No | soggy |
| 2 | 20% | easy | 100% | No | firm |
| 3 | 40% | easy | 100% | No | firm |

In the above tests, 100% winder speed was achieved with all samples.

Although easy winding and 100% fiber tear was obtained with all samples, the unfoamed samples produced a soggy core due to the increased amount of glue on the web and a reduced drying time as the machine speed increased. By contrast the foamed adhesives of the present invention have less water by volume, therefore reducing drying time and producing a firm core.

### Example 2

A medium solids, repulpable EVA adhesive, specifically designed for corewinding, and available under the tradename CORETITE® from National Starch and Chemical Company was evaluated; the control was pure adhesive which was compared to a sample foamed to 40% air by weight. The following was observed:

With the control, the wind started with ease. It was observed that the amount of adhesive applied increased as the winder speed increased. As the machine speed was increased to over 60%, the increase of the wet adhesive caused the plies to slip, resulting in a stoppage of the corewinder machine.

With the foamed sample, the wind started with ease, and the adhesive coated the applicator roll evenly. At initial start up speed, the cores were firm and there were no “dog ears”. As the winder speed increased, there was no need for adhesive adjustment up to 100% machine speed. Up to 100% machine speed, acceptable cores, without dog ears were produced.

These results indicate that introduction of foam into the sample allows for wider range of winder speeds without adhesive adjustment.

### Example 3

A polyvinyl acetate emulsion with a viscosity of 1500 cPs and available under the tradename PRODUCER® from National Starch and Chemical Company was evaluated; the control was pure adhesive which was compared to a sample foamed to 40% air.

With the control, the wind started with ease and core quality was good at the start of the process. Core quality remained good at 50% and 80% machine speeds even though the adhesive application rate was increasing as the speed increased. It was observed that the amount of adhesive on the web increased as the machine speed increased. The machine was run up to 90% speed and produced cores that were too soggy to withstand the downstream tissue converting process. When the machine was run at 100% speed (350 fpm) the core would not hold together because of the excessive amount of glue. Specifically, when the speed was increased to 100% the plies slipped causing the machine to stop.

With the foamed sample, wind started with ease and core quality at the early stage of the process was acceptable. As the winder speed was increased up to 100% (350 fpm) the core quality remained acceptable with stiffer cores and no dog ears observed after the cutting stage.

In the above evaluation 100% winder speed was achieved with the foamed sample. These results indicate that introduction of foam into the adhesive sample allows for a wider range of winder speeds to be achieved.

What is claimed is:

1. A paper core or tube comprising an adhesive which has been foamed to up to 40% by weight.

2. A method for preparing a paper core or tube, the improvement comprising applying an adhesive foamed to up to 40% by weight.

3. A paper core or tube comprising one or more paper or paperboard materials bonded together with an adhesive which has been foamed to up to 40% by weight.

4. A paper core or tube according to claim 1 or 3 wherein the tube or core is used in the tissue, towel, carpet, textile, plastic film, paper, food and industrial storage industries.
